(19) United States
(12) Patent Application Publication
(10) Pub. No.: US 2026/0169176 A1
(43) Pub. Date: Jun. 18, 2026

(54) Device for detecting ionizing radiation

(71) Applicant: RAYLAB SRL, SAN ZENO NAVIGLIO (BS) (IT)

(72) Inventors: Davide MAZZUCCONI, Piazza Leonardo da Vinci (IT); Andrea POLA, Piazza Leonardo da Vinci (IT); Dario RASTELLI, SAN ZENO NAVIGLIO (BS) (IT); Davide BORTOT, Piazza Leonardo da Vinci (IT)

(21) Appl. No.: 19/352,978

(22) Filed: Oct. 8, 2025

(30) Foreign Application Priority Data
Oct. 9, 2024 (IT) 102024000022494

(51) Int. Cl. G01T 1/185

(52) U.S. Cl. CPC G01T 1/185

(57) ABSTRACT

A device for detecting ionizing radiation, the device including a main body provided with an internal cavity having axial symmetry around a central axis; a plurality of detection elements being structured to be placed at a respective electrical voltage difference with respect to the main body to generate a respective charge signal representative of an amount of electrical charge collected by the detection element, wherein the detection elements are arranged inside the internal cavity spatially separated from each other and in spatial sequence along the central axis, and wherein each detection element has axial symmetry around the central axis.

### TECHNICAL FIELD OF THE INVENTION

The present invention regards a device for detecting an ionizing radiation. The present invention regards also a detection system of an ionizing radiation comprising said device, and a method for detecting an ionizing radiation.

### STATE OF THE ART

By “ionizing radiation” it is meant a radiation having energy sufficient to release, following interaction, one or more electrons from atoms creating one or more electron-ion pairs. Electromagnetic waves (e.g. X-rays, gamma rays) as well as corpuscular radiations (that is particle beams, e.g. alpha particles, beta particles, neutrons) can constitute ionizing radiation.

Devices for detecting an ionizing radiation based on the use of a body provided with an internal cavity, which is typically filled with a gas, and inside which an electrode is arranged, are known. In said devices an electric field is established between the walls of the body that delimit said cavity and the electrode inside said cavity, in order to realize a migration towards one or the other of the two elements of the charged particles generated inside the gas following the interaction with the ionizing radiation. Typically the body that delimits the cavity is polarized at a negative voltage (cathode), whereas the internal electrode is polarized at a positive voltage (anode).

In general the operating principle of said devices comprises first the interaction, direct or indirect, between the ionizing radiation and the filling gas of the cavity, said filling gas being ionized creating one or more electron-ion pairs. The number of pairs generated is typically proportional to the energy deposited in the gas by the ionizing radiation. By indirect interaction it is typically meant that the radiation interacts initially with the walls of the body that realizes the cavity, releasing electrically charged particles, said electrically charged particles being in turn able to ionize the gas inside the cavity.

Subsequently the electron-ion pairs created, under the effect of said electric field established between anode and cathode, separate. The electrons, in particular, are attracted towards the anode.

Along the path towards the anode, the electrons, accelerating according to the lines of the electric field, acquire enough energy to be in turn able to further ionize the gas. Said cascade process generates an avalanche of charged particles (e.g. further electrons), said avalanche being called Townsend avalanche.

The electrons of the avalanche once reached the anode are globally collected by the anode generating a corresponding charge signal that can be measured by appropriate instrumentation. In particular, the process of generating the avalanche amplifies the signal making said signal measurable by said instrumentation.

An example of said devices is represented by proportional counters, in which the electrical charge overall generated by the Townsend avalanche is on average proportional to the charge initially generated by the ionizing radiation, and therefore to the energy deposited in the gas by said ionizing radiation.

A subcategory of proportional counters is represented by tissue-equivalent proportional counters (also called TEPC, from “tissue equivalent proportional counter”), that is devices able, thanks to the choice of low atomic number materials and specific gas mixtures (said materials and gases being respectively tissue-equivalent), to simulate the human biological tissue, in order to study the interaction between the ionizing radiation and said biological tissue.

### SUMMARY OF THE INVENTION

In said context of devices for detecting the ionizing radiation, in particular in the field of tissue-equivalent proportional counters, the Applicant has carried out the following considerations.

First, the Applicant has observed that the effectiveness of a radiotherapy treatment on the human body is strictly correlated to the physics of the interactions of the ionizing radiation with the biological tissue that occur at cellular and/or subcellular level. The local deposition of energy in the biological tissue by the radiation indeed triggers a sequence of processes that induce a biological response strongly dependent on the stochasticity of the interactions and of the energy depositions occurred therein.

In particular, the Applicant deems to be of fundamental importance to be able to detect the spatial arrangement of the ionizations generated by the ionizing radiation at the level of the DNA chains, that is in subcellular volumes, typically having dimensions in the order of a few tens of nanometers (e.g. in the order of 25 nm). In other terms, the Applicant deems fundamental to be able to trace back the spatial track of the ionization events generated by the ionizing radiation during its passage in the biological tissue. This in order to describe with desired accuracy the damage caused by the ionizing radiation and, from this, estimate the potential effectiveness of the radiotherapy treatment.

Moreover, the Applicant has also perceived the need to detect the ionizing radiation, in particular said track of the ionizations, with desired precision and/or accuracy. In particular the Applicant deems particularly advantageous to be able to detect as many ionization events as possible inside the volume of the cavity, in order to have a desired number of information to reconstruct the track.

What above must furthermore be able to be obtained by means of a device that results structurally simple and/or of reduced dimensions.

The Applicant has therefore addressed the problem of detecting an ionizing radiation, in particular in terms of spatial arrangement (e.g. in a given volume) of the ionization events generated by said ionizing radiation, with desired precision and/or accuracy and in a structurally simple way and/or with a device of reduced dimensions.

According to the Applicant said problem is solved by a device for detecting an ionizing radiation in accordance with the attached claims and/or having one or more of the following features.

According to one aspect the invention relates to a device for detecting ionizing radiation.

The device comprising:
a main body made of electrically conductive material provided with an internal cavity;
a plurality of detection elements made of electrically conductive material, each detection element being structured to be placed at a respective electrical voltage difference with respect to said main body to generate, independently from the remaining detection elements, a respective charge signal representative of an amount of electrical charge collected by said each detection element.

Preferably said internal cavity has axial symmetry around a central axis.

Preferably said detection elements are arranged inside said internal cavity spatially separated from each other.

Preferably said detection elements are arranged in spatial sequence along said central axis.

Preferably each of said detection elements has axial symmetry around said central axis.

According to another aspect, the invention relates to a detection system of an ionizing radiation.

The system comprises:
the device for detecting ionizing radiation according to the present invention;
a gas delivery apparatus connected to said internal cavity and structured to deliver a measuring gas into said internal cavity;
a power supply source connected to said device and structured to apply a respective electrical voltage difference between said main body and each detection element to generate an electric field between said main body and each detection element;
an elaboration unit operatively connected to said device and configured to:
   receive as input one or more respective charge signals from one or more corresponding detection elements,
   derive information representative of a spatial arrangement of ionization events generated by said ionizing radiation in said internal cavity as a function of said one or more respective charge signals and a spatial coordinate along said central axis of said one or more corresponding detection elements.

According to a further aspect, the invention relates to a method for detecting ionizing radiation.

The method comprises:
providing the detection device for detecting ionizing radiation according to the present invention;
delivering a measuring gas into said internal cavity;
applying a respective electric voltage difference between said main body and each detection element to generate an electric field between said main body and each detection element;
obtaining one or more respective charge signals from one or more corresponding detection elements;
deriving information representative of a spatial arrangement of ionization events generated by said ionizing radiation in said internal cavity as a function of said one or more respective charge signals and a spatial coordinate along said central axis of said one or more corresponding detection elements.

By the expression “amount of electrical charge collected” it is meant the overall value of electrical charge transferred to the detection element by charged particles (typically electrons) generated in the internal cavity following the interaction between the atoms of the gas in the cavity and the ionizing radiation when said charged particles, under the action of the electric field that is established between each detection element and the main body, reach the detection element.

According to the Applicant, the internal cavity of the main body allows to effectively simulate regions of biological tissue having the desired dimensions, in particular said subcellular dimensions of the DNA chains in the order of a few tens of nanometers.

Indeed, by filling the internal cavity with an appropriate gas (e.g. a tissue-equivalent gas) at a suitable pressure (e.g. in the order of tenths of mbar), it is possible to make the macroscopic volume of gas contained in the cavity behave, with regard to the response to the ionizing radiation in terms of ionization events, in a way analogous to a portion of biological tissue having nanometric dimensions, thus simulating said portion of biological tissue.

The presence of the main body and, overall, of the plurality of detection elements, structured to be placed each at a respective electrical voltage difference with respect to the main body, allows to realize the electrodes, e.g. cathode and anode, towards which the electrically charged particles generated following the interaction between the ionizing radiation and the gas contained in the cavity migrate.

The plurality of detection elements, arranged inside the internal cavity spatially separated from each other and structured as described above, furthermore allows to spatially discretize the corresponding electrode (preferably the anode) into a plurality of portions independently sensitive to the amounts of electrical charge of the charged particles that interact with said portion of electrode.

In this way it is possible to trace back, as a function of the respective charge signals and of the spatial coordinate of the corresponding detection elements, the spatial distribution of the ionization events generated by the ionizing radiation inside the gas, that is the track of the ionizations in space.

Without wishing to be bound to any theory, the Applicant indeed deems that, given an ionization event of the gas occurred in a given spatial position inside the cavity, it is possible to conclude with good approximation that the respective avalanche of charged particles migrates, in its motion towards the detection elements, along a migration direction substantially parallel to the field lines of the electric field that is established between the main body and the detection elements themselves, in such a way involving, once reached the plurality of detection elements, only the detection element, or the detection elements, closest to said migration direction.

In this way it is therefore possible to trace back the position of the single ionization event correlating each other the charge signals and the spatial coordinates along the central axis of the corresponding detection elements that have generated said charge signals.

Finally, the axial symmetry of the internal cavity, in synergy with the axial symmetry of the detection elements themselves around the same central axis of the internal cavity, allows to obtain the desired precision and/or accuracy of detection of the radiation. In particular said features allow to obtain an isotropic detection response around the central axis of the cavity, that is allow to detect ionization events inside the cavity independently from the incidence direction of the ionizing radiation.

Indeed, thanks to said geometric features of symmetry and positioning, by the detection elements it is possible to collect a charge deriving from any ionization event with a sensitive angle of 360° around the central axis without variation of the detection capabilities as the position of the event varies with respect to the central axis, and therefore obtaining a desired number of information for the reconstruction of the spatial track of the ionization events.

Moreover, the combination of said features allows to keep the device structurally simple and, if desired, also of limited overall dimensions, obtaining at the same time a device able to provide results in terms of track in space of the ionizations due to the ionizing radiation in a sensitive volume relatable to a site of subcellular (nanometric) dimensions, and therefore results at least comparable to those obtainable with the far more complex, expensive and bulky known track nanodosimeters, without however needing to resort to said complications.

The present invention in one or more of said aspects can comprise one or more of the following preferred features.

Preferably each detection element has a respective section, in a plane perpendicular to said central axis, of circular shape. In this way the isotropic response is improved. In one embodiment said respective section has square or polygonal shape (e.g. hexagonal).

Preferably said device comprises a support element shaped to hold said detection elements in position.

Preferably said support element comprises a support portion with main development lying along said central axis.

Preferably each detection element comprises a respective through-opening having development parallel to said central axis.

Preferably said respective through-opening has a section, on a plane perpendicular to said central axis, of circular shape.

Preferably said detection elements are threaded along said support portion of said support element through said respective through-opening. In this way the arrangement of the detection elements is structurally simple. Moreover, by threading the detection elements along the support portion through the respective opening, it is obtained that each detection element is totally free at a respective external surface (i.e. the surface facing away from the central axis), to the advantage of the detection sensitivity of the charged particles.

Preferably said support element, more preferably at least said support portion, comprises a matrix made of electrically insulating material.

Preferably said support element is rigid.

In one embodiment said matrix is a polyamide resin.

In one embodiment said matrix comprises a polymeric material, for example polytetrafluoroethylene (PTFE).

Preferably the polymeric material of the matrix is loaded with a ceramic material, for example silicon oxide (SiO₂).

Said materials have turned out to be particularly advantageous in favour of the tissue-equivalence of the matrix.

Preferably said support element, more preferably said support portion, comprises, for each detection element, a respective electrically conductive contact portion formed on an external surface of said matrix, more preferably superiorly to said external surface of said matrix. By external surface of the matrix it is meant a free surface of the matrix, at least before the application of the detection elements. In this way the electrical contact with the detection elements is provided in a constructively simple manner.

Preferably said respective contact portions are arranged along said support portion. In this way the electrical contact is realized in a structurally simple manner.

Preferably each detection element (e.g. when threaded along the support portion) is electrically connected to the respective contact portion, more preferably by means of a conductive epoxy resin or tin soldering. In this way mechanical fixing and electrical contact are realized at the same time.

Preferably each detection element comprises a respective internal surface that delimits said respective through-opening.

Preferably the respective internal surface of each detection element is directly electrically connected to the respective contact portion, for example by means of said conductive epoxy resin or tin soldering. In this way the arrangement and the electrical connection of the detection elements is highly simplified.

Preferably said support element comprises, for each contact portion, a respective output port to transmit an electrical signal from said each contact portion. Preferably said support element comprises, for each contact portion, a respective electrically conductive track that electrically connects said respective contact portion to said respective output port. Preferably each respective electrically conductive track is formed at said external surface of said matrix, more preferably superiorly to said external surface of the matrix. In this way it is possible to extract the respective charge signals in a structurally simple and economically realizable manner.

In one embodiment said support element is realized by means of a rigid or flexible printed circuit board (“rigid PCB” or “flex PCB”). In other words, said support element is a printed circuit board (PCB).

Preferably said printed circuit board comprises a base body that realizes said matrix. Preferably said respective contact portions and/or said respective conductive tracks are formed on an external surface of said base body (which preferably coincides with the external surface of the matrix). In this way it is structurally simple and economical. Preferably said device comprises a confinement element of an electronic avalanche made of electrically conductive material. Preferably said confinement element is arranged inside said internal cavity in an intermediate position between said main body and said plurality of detection elements. In this way the sensitivity and/or the resolution of the device is improved as the pressure of the gas inside the cavity decreases (and therefore as the dimensions of the simulated site decrease).

Preferably said confinement element is structured to be placed (e.g. by means of said power supply source) at a first electrical voltage difference with respect to said main body and at a second electrical voltage difference with respect to each detection element.

Preferably said confinement element comprises (more preferably consists of) a cylindrical helix having a respective axis coinciding with said central axis. In this way the opacity of the confinement element to the passage of the charged particles (electrons and/or ions) is reduced, improving the detection capabilities.

Preferably said main body is made of A-150 conductive plastic.

Preferably said confinement element is made of tungsten.

Preferably each detection element is made of graphite.

In one embodiment said measuring gas comprises one or more of the following: propane, propane-tissue equivalent (i.e. propane added with nitrogen and oxygen to make it more similar to the biological tissue), dimethyl ether (DME).

One or more of the preceding features allows to improve the capabilities of the device as a tissue-equivalent device.

Preferably each detection element has cylindrical shape (e.g. cylindrical ring) with axis coinciding with said central axis. In this way it is simple to realize.

In one embodiment each detection element has an outer diameter (e.g. moving orthogonally to the central axis) greater than or equal to 1.5 mm and/or less than or equal to 2.5 mm.

In one embodiment each detection element has an inner diameter (e.g. moving orthogonally to the central axis) greater than or equal to 0.7 mm and/or less than or equal to 1.7 mm.

In one embodiment each detection element has thickness (e.g. moving orthogonally to the central axis) greater than or equal to 1 mm and/or less than or equal to 2 mm.

In one embodiment a pitch of said spatial sequence of said detection elements, measured between two centers of directly consecutive detection elements, is greater than or equal to 1.5 mm and/or less than or equal to 2.5 mm.

In one embodiment each detection element has length, along said central axis, greater than or equal to 1 mm and/or less than or equal to 2 mm.

In one embodiment said support portion has length, along said central axis, greater than or equal to 15 mm, more preferably greater than or equal to 20 mm, and/or less than or equal to 35 mm, more preferably less than or equal to 30 mm.

In one embodiment said support portion has a section, in a plane substantially orthogonal to said central axis, of rectangular shape.

In one embodiment said section of said support portion comprises a first dimension between 0.5 mm and 1.5 mm, for example 1 mm.

In one embodiment said section of said support portion comprises a second dimension between 0.2 mm and 0.6 mm, for example 0.4 mm.

The Applicant has realized that the combination of the above dimensional features allows to realize a device of contained dimensions, and therefore portable, to the advantage of the versatility of use.

Preferably said device is configured to operate as a proportional counter, more preferably tissue-equivalent. In this way the precision and/or accuracy is improved.

Preferably said method comprises applying said respective electrical voltage difference by applying said first electrical voltage difference between said main body and said confinement element and said second electrical voltage difference between said confinement element and each detection element.

Preferably said first electrical voltage difference is greater than or equal to 5V and less than or equal to 25V, for example equal to about 15V.

Preferably said second electrical voltage difference is greater than or equal to 450V and less than or equal to 650V, for example equal to about 500V or 600V.

Said electrical voltage values have turned out to be particularly suitable for the above applications.

Preferably applying said respective electrical voltage difference comprises polarizing each detection element at a positive electrical voltage.

Preferably applying said respective electrical voltage difference comprises polarizing said main body at a negative electrical voltage.

In one embodiment said method further comprises:
aggregating each other said respective charge signals to obtain an overall charge signal representative of an amount of electrical charge collected overall by said plurality of detection elements;
deriving information representative of a total energy released by said ionizing radiation in said internal cavity based on said overall charge signal. In this way the device can be used also to obtain information on the total energy, for example in the form of microdosimetric distributions.

Preferably delivering said measuring gas comprises introducing said measuring gas into said internal cavity with a pressure greater than or equal to 0.5 mbar and/or less than or equal to 15 mbar. In this way sites of biological tissue of different dimensions, for example with dimensions ranging between 500 nm and 25 nm, can be simulated, to the advantage of the versatility of the device.

### BRIEF DESCRIPTION OF THE FIGURES

FIG. 1 schematically shows a perspective view of a partial section of the device according to the present invention;

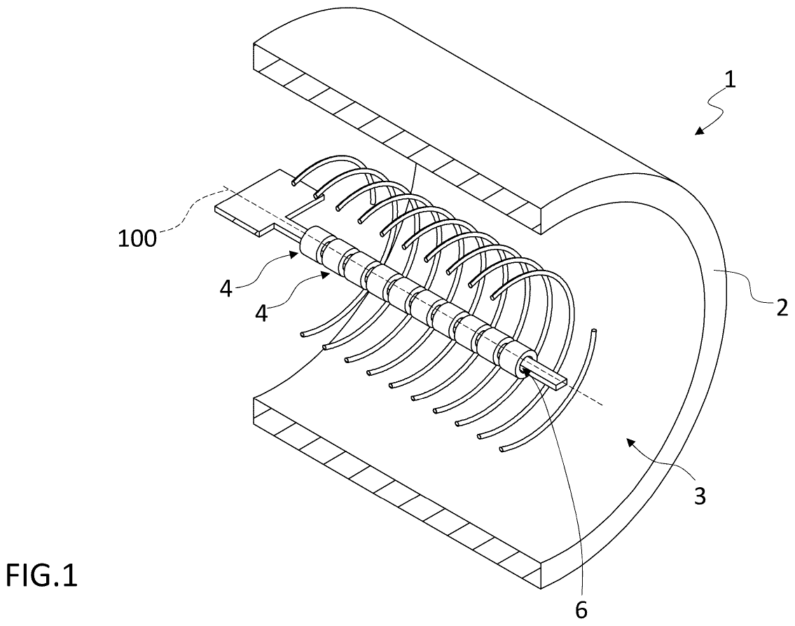

FIG. 2 shows a side view of the device of FIG. 1;

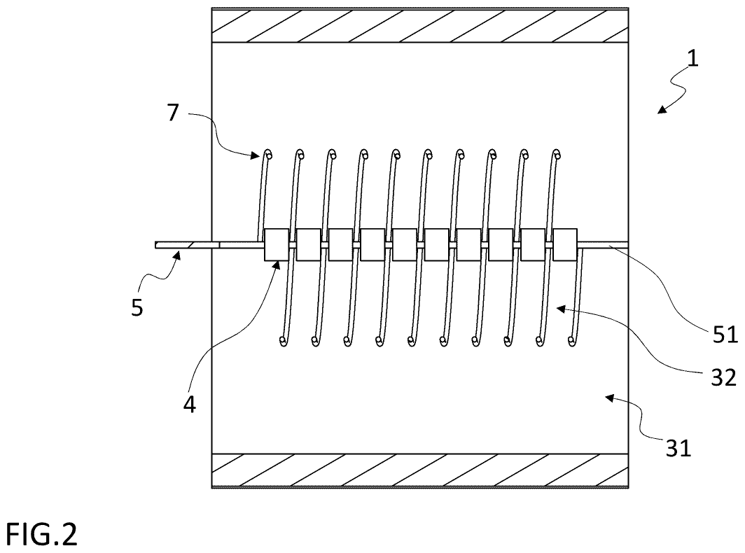

FIG. 3 schematically shows a detection system according to the present invention.

### DETAILED DESCRIPTION OF SOME EMBODIMENTS OF THE INVENTION

The features and advantages of the present invention will be further clarified by the following detailed description of some embodiments, presented by way of example and not limiting the present invention, with reference to the attached figures.

In the figures, with the number 1 a device for detecting an ionizing radiation is globally indicated.

Exemplarily the device 1 comprises a main body 2 made of electrically conductive material, exemplarily A-150 conductive plastic.

Exemplarily the main body 2 comprises an internal cavity 3 having axial symmetry around a central axis 100. More in detail, the internal cavity 3 and the main body 2 have cylindrical shape with axis coinciding with said central axis 100.

Exemplarily the device 1 comprises a plurality of detection elements 4 made of electrically conductive material, exemplarily graphite.

Exemplarily each detection element 4 is structured to be placed at a respective electrical voltage difference with respect to the main body 2 to generate, independently from the remaining detection elements 4, a respective charge signal CS representative of an amount of electrical charge collected by the detection element 4.

Exemplarily the detection elements 4 are arranged inside the internal cavity 3 spatially separated from each other and in spatial sequence along the central axis 100.

Exemplarily each detection element 4 furthermore has axial symmetry around the central axis 100. More in detail, each detection element has cylindrical shape and therefore a respective section, in a plane (not shown) perpendicular to the central axis 100, of circular shape.

Exemplarily the device 1 furthermore comprises a support element 5 shaped to hold in position the detection elements 4.

More in detail, the support element 5 exemplarily comprises a support portion 51 having main development lying along the central axis 100. Exemplarily the support portion 51 has parallelepiped shape with main dimension arranged along the central axis 100.

Exemplarily furthermore each detection element 4 comprises a respective through-opening 6 (exemplarily the detection elements 4 have hollow cylinder shape) having development parallel to the central axis 100, wherein the detection elements 4 are exemplarily threaded along the support portion 51 of the support element 5 through the respective through-opening 6. Exemplarily said respective through-opening 6 has a section, on a plane perpendicular to the central axis 100, of circular shape.

Exemplarily the support element 5 (more in detail the support portion 51) is rigid and comprises a matrix made of electrically insulating material. The matrix can be for example a polyamide resin.

In one embodiment the matrix can comprise a polymeric material, for example polytetrafluoroethylene (PTFE), loaded with a ceramic material, for example silicon oxide (SiO₂), such as for example RO3003™ marketed by Rogers Corporation.

Exemplarily the support element 5 (more in detail the support portion 51) furthermore comprises, for each detection element 4, a respective electrically conductive contact portion (not shown) formed at an external surface of the matrix, more in detail superiorly to the external surface of the matrix. In particular, the respective contact portions are exemplarily arranged along the support portion 51, for example at (on) a (same) face of the parallelepiped shape of the support portion 51, to be suitably contacted by the detection elements 4 when threaded.

Exemplarily each detection element 4, when threaded along the support portion 51, is electrically connected to the respective contact portion, for example by means of a conductive epoxy resin or tin soldering (not shown).

More in detail, each detection element 4 exemplarily comprises a respective internal surface, which delimits the respective through-opening 6, directly electrically connected to the respective contact portion, for example by means of said conductive epoxy resin or tin soldering.

Exemplarily (not shown) the support element 5 comprises, for each contact portion, a respective output port to transmit an electrical signal coming from the contact portion, and comprises, for each contact portion, a respective electrically conductive track that electrically connects the respective contact portion to the respective output port. Exemplarily each respective electrically conductive track is formed at (on) the external surface of the matrix.

Exemplarily the support element 5 is realized by means of a rigid printed circuit board (“rigid PCB”), for example in FR4. In one embodiment the support element can be realized by a flexible printed circuit board (“flex PCB”). In other words, the support element 5 is a printed circuit board. Exemplarily the printed circuit board comprises a base body that realizes the matrix. Exemplarily the respective contact portions and the respective conductive tracks are formed, for example by means of known “etching” techniques, on an external surface of the base body (which coincides with the external surface of the matrix).

Exemplarily the device 1 furthermore comprises a confinement element 7 of an electronic avalanche made of electrically conductive material, for example tungsten. Exemplarily the confinement element 7 is arranged inside the internal cavity 3 in an intermediate position between the main body 2 and the plurality of detection elements 4.

Exemplarily the confinement element 7 is structured to be placed at a first electrical difference with respect to the main body 2 and at a second electrical voltage difference with respect to each detection element 4.

Exemplarily the confinement element consists of a cylindrical helix having a respective axis coinciding with the central axis 100.

Exemplarily the detection elements 4 are in number equal to 10.

In one exemplary embodiment, the detection elements have outer diameter equal to about 2 mm, inner diameter equal to about 1.2 mm and thickness (radially) equal to about 1.5 mm. In said embodiment, a pitch of the spatial sequence of the detection elements, measured between two centers of directly consecutive detection elements, is equal to about 2 mm, the detection elements being for example long (parallel to the central axis 100) 1.5 mm and spaced from each other by about 0.5 mm.

Still in said exemplary embodiment, the support portion 51 has length, along the central axis 100, equal to about 25 mm, with section, in a plane (not shown) substantially orthogonal to the central axis 100, of rectangular shape with sides about 1 mm×0.4 mm.

For example the confinement element 7 has outer diameter equal to about 12 mm, thickness of the filament that realizes the helix equal to about 0.2 mm, and axial length equal to about 20 mm.

For example the main body 2 has outer diameter equal to about 24 mm, inner diameter equal to about 20 mm and length (along the axis) equal to about 25 mm.

Exemplarily the device is configured to operate as a proportional counter, in particular of the tissue-equivalent type.

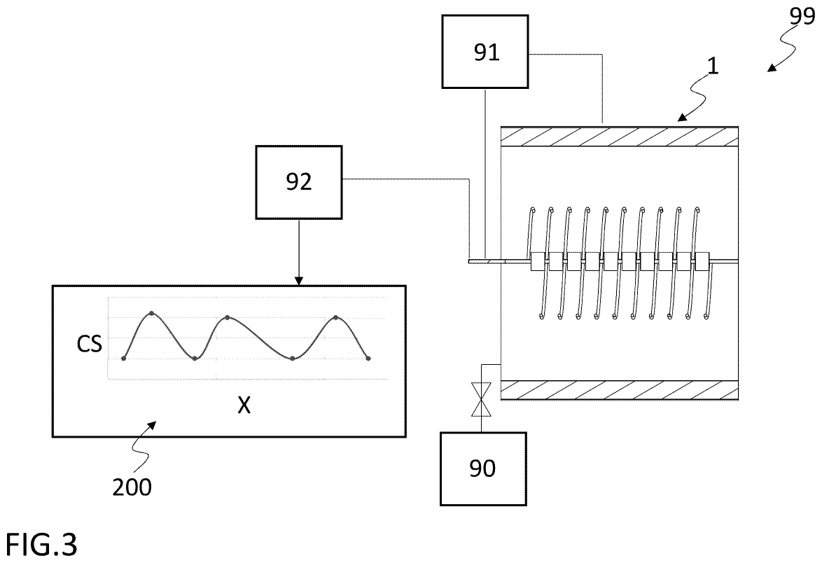

With reference to FIG. 3, FIG. 3 shows a detection system 99 of the ionizing radiation.

Exemplarily the system 99 comprises the device 1 for detecting the ionizing radiation. Exemplarily the system 99 furthermore comprises a gas delivery apparatus 90 (shown only schematically) connected to the internal cavity 3 and structured to deliver a measuring gas into the internal cavity.

For example the apparatus can comprise a cylinder of measuring gas suitably connected to the internal cavity 3.

Exemplarily the system 99 comprises a power supply source 91 (shown only schematically) connected to the device 1 and structured to apply a respective electrical voltage difference between the main body 2 and each detection element 4 to generate an electric field between the main body 2 and each detection element 4.

Exemplarily the system 99 furthermore comprises an elaboration unit 92 (shown only schematically) operatively connected to the device 1. More in detail the elaboration unit is connected to the output ports of the support element 5 of the device to receive as input the charge signals coming from each detection element 4, as better described below.

In use, the system 99 allows to perform a method for detecting an ionizing radiation. The ionizing radiation detectable can be directly ionizing radiation (e.g. proton beam, gamma rays, alpha particle beam, etc.), or indirectly ionizing radiation, such as for example a neutron beam. In a preferred embodiment the radiation to be detected is represented by a neutron beam (from source, for example an Am-Be neutron source, or from particle accelerator). The ionizing radiation beam to be detected is therefore directed against the main body 2 of the device 1.

Exemplarily it is initially provided to deliver a measuring gas into the internal cavity 3, for example a tissue-equivalent gas such as propane, propane-tissue equivalent, dimethyl ether (DME). Preferably, before delivering the gas into the cavity, it is provided to aspirate air from the cavity up to an internal pressure equal to about 10⁻³ mbar.

Exemplarily the pressure of the measuring gas can vary from about 0.5 mbar to about 15 mbar. The higher the pressure, the greater the equivalent dimensions of the simulated biological tissue site. For example at a pressure equal to about 0.69 mbar, the simulated site has main dimension of about 25 nm.

Exemplarily it is therefore provided to apply the respective electrical voltage difference between the main body 2 and each detection element 4 to generate the electric field between the main body 2 and each detection element 4. Exemplarily the main body 2 is polarized at negative electrical voltage and each detection element 4 is polarized at positive electrical voltage.

Exemplarily it is therefore provided, for example by the elaboration unit 92, to obtain one or more respective charge signals CS from respectively one or more corresponding detection elements 4.

Exemplarily the charge signals can be obtained as known, that is digitally converting (through a suitable ADC) an electrical voltage signal received from each corresponding detection element upon the collection of a respective amount of charge. Optionally the electrical voltage signal can be amplified in one or more stages before the conversion, for example by means of a charge pre-amplifier and a subsequent charge amplifier.

The amount of charge collected by each detection element corresponds exemplarily to at least a portion of electrons of the electronic avalanche generated following an ionization event. By calibrating the device 1 at suitable supply voltages it is possible to make the device 1 operate in proportional regime so that the amount of charge collected is, on average, proportional to the energy released in the gas by the ionizing radiation in the given ionization event that has generated the specific electronic avalanche detected.

For example the electrical voltage difference between the main body and the confinement element 7 is equal to about 15V, whereas the voltage between the confinement element 7 and each detection element 4 is equal to about 550V. The confinement element 7 is also exemplarily polarized at positive electrical voltage.

The region of internal cavity 3 that is formed between the main body and the confinement element is defined drift region 31. In said region the charged particles created by the ionization event migrate towards the corresponding electrode, typically without generating further ionizations. In the example described the electrons created migrate towards the confinement element, typically following the lines of the electric field, and therefore typically along radial directions with respect to the central axis 100.

The region of internal cavity 3 that is formed between the confinement element 7 and the detection elements 4 is instead defined multiplication region 32. In said region the charged particles generated by the ionization events occurred in the drift region continue their migration towards the respective electrode, however generating further ionizations inside the gas (generating the above-mentioned Townsend avalanche). Exemplarily the electrons that have passed the confinement element 7 migrate along radial directions with respect to the central axis 100 towards the detection elements 4 generating at the same time new ionizations.

Exemplarily it is therefore provided to derive, for example by the elaboration unit 92, information 200 representative of a spatial arrangement of ionization events generated by the ionizing radiation in the internal cavity 3 as a function of the one or more respective charge signals CS and of a spatial coordinate X along the central axis 100 of the one or more corresponding detection elements 4.

In detail, the information 200 can be graphed as shown purely by way of example in FIG. 3, where on the abscissa axis the spatial coordinate X along the central axis 100 is shown (e.g. discretized at the positions of the detection elements 4 along the axis 100), whereas on the ordinate axis the charge signal CS (or a quantity directly derived from it) is shown.

Correlating therefore the respective charge signals CS to the spatial coordinates X of the detection elements 4 that have generated said signals, it is exemplarily possible to reconstruct the spatial track of the ionization events occurred in the internal cavity 3 by the ionizing radiation. In particular, whenever the charge signal CS records an ionization event (that is the signal is for example greater than a given threshold), this information is correlated to the spatial coordinate X of the detection element 4 (or detection elements) that has (have) generated said signal, in this way obtaining said information 200.

In the example shown in FIG. 3, it is possible for example to conclude that at least three ionization events have occurred in the gas (corresponding to the three peaks of the curve shown in FIG. 3), for example spatially located at the third, fifth and ninth detection element 4 from left. From said information it is therefore possible to trace back the spatial track of the ionizations occurred in the gas along the central axis 100. In one embodiment (not shown) the method can furthermore comprise aggregating each other the respective charge signals to obtain an overall charge signal representative of an amount of electrical charge collected overall by the plurality of detection elements 4, and deriving information representative of a total energy released by the ionizing radiation in the internal cavity 3 as a function of the overall charge signal, for example in order to derive said information in the form of microdosimetric distributions (as for example known). In this way the device can provide information both in terms of track of the events and in terms of microdosimetric quantities, thus being able to operate both as track nanodosimeter and as microdosimeter.

1. A device for detecting ionizing radiation, said device comprising:
a main body made of electrically conductive material provided with an internal cavity, said internal cavity having axial symmetry around a central axis;
a plurality of detection elements made of electrically conductive material, each detection element being structured to be placed at a respective electrical voltage difference with respect to said main body to generate, independently from the remaining detection elements, a respective charge signal (CS) representative of an amount of electrical charge collected by said each detection element,
wherein said detection elements are arranged inside said internal cavity spatially separated from each other and in spatial sequence along said central axis,
and wherein each of said detection elements has axial symmetry around said central axis

2. The device according to claim 1, wherein each detection element has a respective section, in a plane perpendicular to said central axis, of circular shape.

3. The device according to claim 1, comprising a support element shaped to hold said detection elements in position, wherein said support element comprises a support portion with main development lying along said central axis wherein each detection element comprises a respective through-opening having main development parallel to said central axis and wherein said detection elements are threaded along said support portion of said support element through said respective through-opening.

4. The device according to claim 3, wherein said support element comprises a matrix made of electrically insulating material and comprises, for each detection element, a respective electrically conductive contact portion formed on an external surface of said matrix, said respective contact portions being arranged along said support portion, wherein each detection element is electrically connected to the respective contact portion, wherein said support element comprises, for each contact portion, a respective output port to transmit an electrical signal from said respective contact portion and a respective electrically conductive track electrically connecting said respective contact portion to said respective output port, and wherein each respective electrically conductive track is formed at said external surface of said matrix.

5. The device according to claim 3, wherein said support element is realized by a rigid or flexible printed circuit board.

6. The device according to claim 1, comprising a confinement element of an electronic avalanche made of electrically conductive material, said confinement element being arranged inside said internal cavity in an intermediate position between said main body and said plurality of detection elements, wherein said confinement element is structured to be place at a first electrical voltage difference with respect to said main body and a second electrical voltage difference with respect to each detection element, and wherein said confinement element comprises a cylindrical helix having a respective axis coinciding with said central axis.

7. The device according to claim 6, wherein said main body is made of A-150 conductive plastic, wherein said confinement element is made of tungsten, wherein each detection element is made of graphite and has a cylindrical shape with an axis coinciding with said central axis, wherein each detection element has an outer diameter greater than or equal to 1.5 mm and less than or equal to 2.5 mm, an inner diameter greater than or equal to 0.7 mm and less than or equal to 1.7 mm, and a thickness greater than or equal to 1 mm and less than or equal to 2 mm, wherein a pitch of said spatial sequence of said detection elements, measured between two centers of directly consecutive detection elements, is greater than or equal to 1.5 mm and less than or equal to 2.5 mm, and wherein said device is configured to operate as a proportional counter.

8. A detection system of an ionizing radiation, said system comprising:
the device for detecting ionizing radiation according to claim 1;
a gas delivery apparatus connected to said internal cavity and structured to deliver a measuring gas into said internal cavity;
a power supply source connected to said device and structured to apply a respective electrical voltage difference between said main body and each detection element to generate an electric field between said main body and each detection element;
an elaboration unit operatively connected to said device and configured to:
receive as input one or more respective charge signals (CS) from one or more corresponding detection elements,
derive information representative of a spatial arrangement of ionization events generated by said ionizing radiation in said internal cavity as a function of said one or more respective charge signals (CS) and a spatial coordinate (X) along said central axis of said one or more corresponding detection elements

9. A method for detecting ionizing radiation, said method comprising:
providing the detection device according to claim 1;
delivering a measuring gas into said internal cavity;
applying a respective electric voltage difference between said main body and each detection element to generate an electric field between said main body and each detection element;
obtaining one or more respective charge signals (CS) from one or more corresponding detection elements;
deriving information representative of a spatial arrangement of ionization events generated by said ionizing radiation in said internal cavity as a function of said one or more respective charge signals (CS) and a spatial coordinate (X) along said central axis of said one or more corresponding detection elements

10. The method according to claim 9, and applying said respective electric voltage difference by applying said first electrical voltage difference between said main body and said confinement element and said second electrical voltage difference between said confinement element and each detection element wherein said first electrical voltage difference is greater than or equal to 5V and less than or equal to 25V, where said second electrical voltage difference is greater than or equal to 450V and less than or equal to 650V, wherein said measuring gas comprises one or more of the following: propane, propane-tissue equivalent, dimethyl ether, wherein delivering said measuring gas comprises introducing said measuring gas into said internal cavity with a pressure greater than or equal to 0.5 mbar and less than or equal to 15 mbar, and wherein applying said respective electric voltage difference comprises polarizing each detection element at a positive voltage and said main body at a negative voltage.

11. The method according to claim 9, further comprising:
aggregating said respective charge signals (CS) each other to obtain an overall charge signal representative of a total amount of electric charge collected by said plurality of detection elements;
deriving information representative of a total energy released by said ionizing radiation in said internal cavity based on said overall charge signal.
